(19) United States
(12) Patent Application Publication
(10) Pub. No.: US 2009/0112533 A1
(43) Pub. Date: Apr. 30, 2009

(54) Method for simplifying a mathematical model by clustering data

(75) Inventors: Anthony James Grichnik, Peoria, IL (US); Gabriel Carl Hart, North Pekin, IL (US); Meredith Jaye Cler, Peoria, IL (US); James Robert Mason, Peoria, IL (US); Christos Nikolopoulos, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/980,673

(22) Filed: Oct. 31, 2007

(51) Int. Cl. G06F 17/10

(52) U.S. Cl. 703/2

(57) ABSTRACT

A method for simplifying a mathematical model is disclosed. The method obtains a data set and identifies a plurality of variables within the data set. The method also performs a clustering analysis by dividing the data set into groups, where each group has a cluster center. The method further replaces the plurality of variables with a plurality of cluster distances. The method also uses the plurality of cluster distances as a plurality of independent variables in a model creation process.

### TECHNICAL FIELD

This disclosure relates generally to complex computer-based mathematical models and, more particularly, to simplifying groups of data variables within the models into clusters.

### BACKGROUND

Mathematical models are often used to build relationships among variables by using data records collected through experimentation, simulation, physical measurement, or other techniques. To create a mathematical model, potential variables may need to be identified after data records are obtained. The data records may then be analyzed to build relationships among identified variables.

To produce relatively accurate results involving complex problems such as, for example, medical treatments, mathematical models often involve massive amounts of data. Identifying potential variables becomes difficult in these situations involving enormous amounts of data. This information overload often overwhelms personnel and computing resources utilizing conventional methods for building mathematical models.

One method that has been implemented to organize large amounts of data for use with mathematical models is described by U.S. Patent Application Publication 2006/0230018 A1 (the '018 publication) by Grichnik et al., published on Oct. 12, 2006. The '018 publication describes a computer-implemented method to provide a desired variable subset for use in mathematical models. The method includes obtaining a set of data records corresponding to a plurality of variables. The '018 publication uses the Mahalanobis distance between data in performing a cluster analysis to identify a desired subset of variables.

Although the method of the '018 publication is effective in identifying a desired subset of variables, it may not be sufficiently efficient with computation resources as the number of variables increase. This may undesirably increase computation time, increase required computing resources, or both. Further, some variable types, such as categorical and Boolean variables, may not be compatible with the Mahalanobis distance calculation the '018 patent describes.

The present disclosure is directed to improvements in the existing technology.

### SUMMARY OF THE DISCLOSURE

In one aspect, the present disclosure is directed to a method for simplifying a mathematical model. The method includes obtaining a data set and identifying a plurality of variables within the data set. The method also includes performing a clustering analysis by dividing the data set into groups, where each group has a cluster center. The method further includes replacing the plurality of variables with a plurality of cluster distances. The method also includes using the plurality of cluster distances as a plurality of independent variables in a model creation process.

In another aspect, the present disclosure is directed toward a computer-readable medium comprising program instructions which, when executed by a processor, perform a method that simplifies a mathematical model. The method includes obtaining a data set and identifying a plurality of variables within the data set. The method also includes performing a clustering analysis by dividing the data set into groups, where each group has a cluster center. The method further includes replacing the plurality of variables with a plurality of cluster distances. The method also includes using the plurality of cluster distances as a plurality of independent variables in a model creation process.

### BRIEF DESCRIPTION OF THE DRAWINGS

FIG. 1 is a block illustration of an exemplary disclosed system for simplifying a mathematical model; and

FIG. 2 is a flowchart illustration of an exemplary disclosed method that may be performed by the system of FIG. 1.

### DETAILED DESCRIPTION

Reference will now be made in detail to exemplary embodiments, which are illustrated in the accompanying drawings. Wherever possible, the same reference numbers will be used throughout the drawings to refer to the same or like parts.

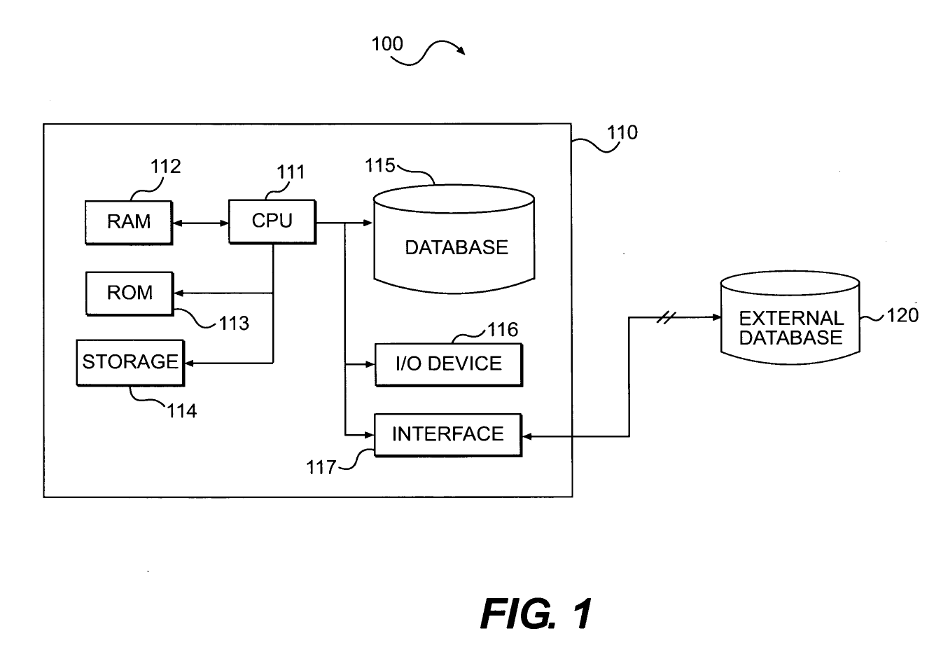

FIG. 1 provides a block diagram illustrating an exemplary environment 100 for variable reduction, model construction, and validation. Environment 100 may include a system 110 and an external database 120. System 110 may be, for example, a general purpose personal computer or a server. Although illustrated as a single system 110, a plurality of systems 110 may connect to other systems, to a centralized server, or to a plurality of distributed servers using, for example, wired or wireless communication.

System 110 may include any type of processor-based system on which processes and methods consistent with the disclosed embodiments may be implemented. For example, as illustrated in FIG. 1, system 110 may include one or more hardware and/or software components configured to execute software programs. System 110 may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may execute sequences of computer program instructions to perform various processes, which will be described in detail below. The computer program instructions may be loaded into RAM 112 for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and CPU 111. Database 115 may store data collected by system 110.

I/O device 116 may include one or more components configured to communicate information to a user associated with system 110. For example, I/O devices may include a console with an integrated keyboard and mouse to allow a user to input parameters associated with system 110. I/O device 116 may also include a display, such as a monitor, including a graphical user interface (GUI) for outputting information. I/O devices 116 may also include peripheral devices such as, for example, a printer for printing information and reports associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as an output from system 110 to I/O device 116 for printed display, viewing, and/or further communication to other system devices. Output from system 110 may also be provided to database 115 and to external database 120.

Interface 117 may include one or more components configured to transmit and receive data via a communication network, such as the Internet, a local area network, a workstation peer-to-peer network, a direct link network, a wireless network, or any other suitable communication platform. In this manner, system 110 may communicate with other network devices, such as external database 120, through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

Those skilled in the art will appreciate that all or part of systems and methods consistent with the present disclosure may be stored on or read from other computer-readable media. Environment 100 may include a computer-readable medium having stored thereon machine executable instructions for performing, among other things, the methods disclosed herein. Exemplary computer readable media may include secondary storage devices, such as hard disks, floppy disks, and CD-ROM; or other forms of computer-readable memory, such as read-only memory (ROM) 113 or random-access memory (RAM) 112. Such computer-readable media may be embodied by one or more components of environment 100, such as CPU 111, storage 114, database 115, and external database 120.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs, modules, etc., may be implemented using commercially available software tools, using custom object-oriented code written in the C++ programming language, using applets written in the Java programming language, or may be implemented with discrete electrical components or as one or more hardwired application specific integrated circuits (ASICs) or field-programmable gate arrays (FPGAs) that are custom-designed for this purpose.

The described implementation may include a particular network configuration, but embodiments of the present disclosure may be implemented in a variety of data communication network environments using software, hardware, or a combination of software and hardware to provide the processing functions.

External database 120 may store any information useful in building a mathematical model. An exemplary model may be one relating to identifying potential health risks. Data relating to this type of mathematical model may include an individual's height, weight, blood pressure, resting pulse, x-ray results, lab test results, health history, name, ethnicity, contact information (e.g., mailing address, e-mail address, phone numbers), the individual's insurance company and doctors, and any other information that may be useful for predicting a health risk. In this exemplary embodiment, external database 120 may also store one or more algorithms for a mathematical model predicting whether an individual will contract a disease and determining whether the individual may reduce their risk of contracting a disease by making lifestyle changes. Although several examples of health information have been provided, many other types of health information may be stored in external database 120 as needed to predict, identify, and treat a variety of diseases. Although not illustrated, one or more servers may contain external database 120. A server may collect data from a plurality of systems 110 to provide a central repository. Moreover, external database 120 may include one or more databases that are in the same or different location.

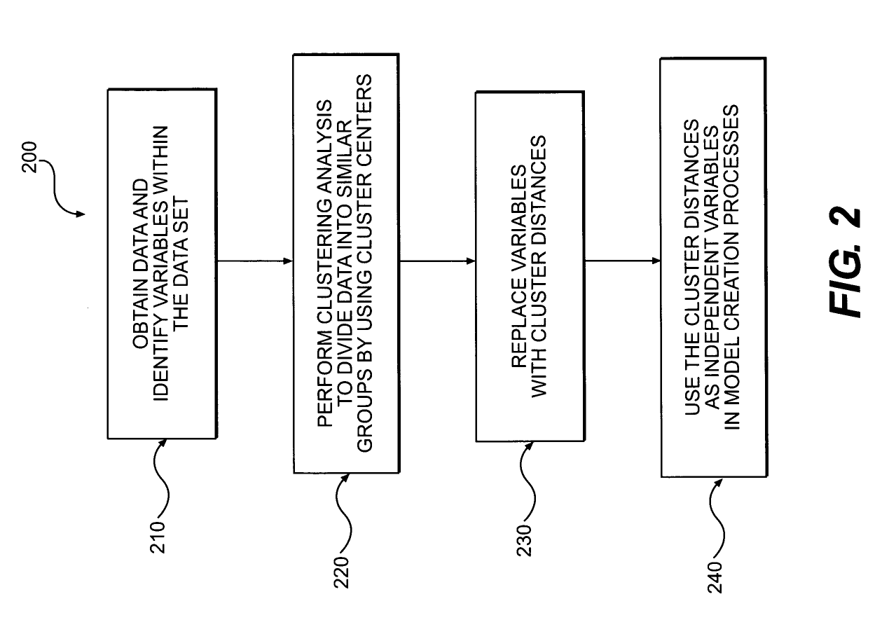

Exemplary processes and methods consistent with the disclosure will now be described with reference to FIG. 2.

### INDUSTRIAL APPLICABILITY

The disclosed methods and systems may provide a technique for preparing large amounts of data and variables for use in a mathematical model. The method may eliminate large amounts of variables by replacing them with a relatively small number of cluster distances. Since these cluster distances may serve as independent variables in the creation of mathematical models, accurate models requiring fewer independent variables may be created. This action satisfies the need to increase the information density in the resulting computation system, as described by criterion such as the Akaike Information Criterion (AIC), the Schwarz Information Criterion (SIC), the Deviance Information Criterion (DIC), or other related metrics of model efficiency.

FIG. 2 is a flowchart illustration of an exemplary disclosed method 200 for simplifying a mathematical model by clustering. Method 200 may begin with system 110 obtaining data and storing the data. System 110 may store the data in, for example, database 115 and external database 120 (Step 210). Obtaining the data may also include identifying variables to be used in the data set. For example, referring to the example health risk model described above, system 110 may gather health information from a variety of private and public sources, such as voluntary surveys, medical claims data, prescription drug claim data, and lab test data. An exemplary data set may include hundreds or thousands of attributes (i.e., hundreds or thousands of variables) pertaining to the medical condition of any number of patients over a period of time.

Next, system 110 may be used to perform a clustering analysis to divide the data into similar groups by using cluster centers (Step 220). The clustering analysis may be carried out by any suitable means known in the art such as, for example, k-means clustering, city block method, and support vector machines. These and similar methods are disclosed in numerous references available in the public domain. The optimal number of groups for the clustering analysis may be determined based on the data collected in step 210 as is well known in the art. Execution of step 220 may result in the data being divided into groups of similar data. Continuing with the medical example described above, a data sample relating to thousands of patients may be clustered to divide the set of patients into subsets of patients having similar attributes (i.e., variables). Specifically, some or all of the variables may be selected to identify like groups of patients, until all patients have been divided into groups. Each group may be based on a different subset of variables from the overall variable set.

Step 220 may utilize cluster centers in dividing the data into similar groups. In forming each group, one exemplary data subject is selected to become the cluster center of each group. To use the medical example, the cluster center may be the exemplary patient—the patient which, based on the subset of variables for that group, all of the other patients in the group most resemble.

Next, system 110 may replace the variables of each group with cluster distances (Step 230). A cluster distance of a given data subject may be the distance of all of the variable values of that data subject to all of the variable values of the cluster center of its own group (as mathematically measured through a cluster analysis method known in the art). The cluster distance of that data subject may also be taken as the distance to the cluster center of a different group. The cluster distances of each data subject may replace the variables describing that data subject. The total number of cluster distances per data subject may therefore be equal to the total amount of groups within the data set. Using the medical example, the attributes of patients are compared to the exemplary patient of their own group and to the exemplary patient of every other group. Instead of being described by hundreds or thousands of attributes (i.e., variables), each patient may now be fully described by a comparison (i.e., cluster distance) to each group's exemplary patient. For example, if a set of patients is divided into ten groups, there may be a total of ten exemplary patients. Therefore, each patient may be fully described by a total of ten comparisons, one to each exemplary patient.

Finally, the cluster distances may be used as independent variables in the creation of a mathematical model (Step 240). For example, the cluster distances may be used in a model related to manufacturing and/or a general process. Continuing with the medical example, the comparisons (i.e., cluster distances) of a given patient to exemplary patients may be used as variables in a model designed to diagnose that patient for diseases and other health risks.

The method may be a lossless compression method, meaning that the original data (i.e., the patient attributes or variables) may be reconstructed from the compressed data (i.e., the patient comparisons or cluster distances). The cluster distances between a given data subject (i.e., patient) and the cluster centers (i.e., exemplary patients) may be used to reconstruct the original variables (i.e., attributes) describing that data subject. Therefore, no data may be lost when variables are replaced by cluster distances.

In one embodiment, the method and system may only replace categorical and Boolean variables with cluster distances. In this embodiment, the cluster distances may be used as independent variables in a mathematical model (Step 240), along with continuous and ordinal variables. In an alternative embodiment, no continuous or ordinal variables may be used at all in Step 240. In another alternative embodiment, the method and system may replace categorical, Boolean, continuous, and ordinal variables with cluster distances to be used in Step 240. One skilled in the art will understand that additional alternative embodiments of the method may be used, involving any combination including or excluding categorical, Boolean, continuous, and ordinal variables.

System 110 may use method 200 to prepare large amounts of data and variables for use in a mathematical model. Method 200 may replace large amounts of variables with a relatively small number of cluster distances in Step 230. Because the cluster distances may serve as independent variables in the creation of mathematical models in Step 240, accurate models requiring fewer independent variables may be created. This makes model creation more efficient, saving time and lowering risks for error by making data more manageable.

It will be apparent to those skilled in the art that various modifications and variations may be made to the disclosed methods. Other embodiments of the present disclosure will be apparent to those skilled in the art from consideration of the specification and practice of the present disclosure. It is intended that the specification and examples be considered as exemplary only, with a true scope of the present disclosure being indicated by the following claims.

What is claimed is:

1. A method for simplifying a mathematical model, comprising:
obtaining a data set and identifying a plurality of variables within the data set;
performing a clustering analysis by dividing the data set into groups, where each group has a cluster center;
replacing the plurality of variables with a plurality of cluster distances; and
using the plurality of cluster distances as a plurality of independent variables in a model creation process.

2. The method of claim 1, wherein identifying the plurality of variables further includes deciding on types of variables to be included in the data set.

3. The method of claim 2, wherein identifying the plurality of variables includes identifying only categorical and Boolean variables.

4. The method of claim 3, wherein performing the clustering analysis includes performing city block method.

5. The method of claim 4, further including employing a plurality of continuous and ordinal variables in addition to the plurality of independent variables in the model creation process.

6. The method of claim 2, wherein identifying the plurality of variables includes identifying categorical, Boolean, continuous, and ordinal variables.

7. The method of claim 6, wherein performing the clustering analysis includes using k-means clustering or using support vector machines.

8. The method of claim 1, wherein replacing the plurality of variables with a plurality of cluster distances includes employing a lossless compression method.

9. The method of claim 1, wherein the model creation process includes one of a plurality of medical risk stratification models, a plurality of design optimization models, a plurality of control system models, or a plurality of manufacturing process models.

10. A computer-readable medium comprising program instructions which, when executed by a processor, perform a method for simplifying a mathematical model, comprising:
obtaining a data set and identifying a plurality of variables within the data set;
performing a clustering analysis by dividing the data set into groups, where each group has a cluster center;
replacing the plurality of variables with a plurality of cluster distances; and
using the plurality of cluster distances as a plurality of independent variables in a model creation process.

11. The computer-readable medium of claim 10, wherein identifying the plurality of variables further includes deciding on types of variables to be included in the data set.

12. The computer-readable medium of claim 11, wherein identifying the plurality of variables includes identifying only categorical and Boolean variables.

13. The computer-readable medium of claim 12, wherein performing the clustering analysis includes performing city block method.

14. The computer-readable medium of claim 13, further including employing a plurality of continuous and ordinal variables in addition to the plurality of independent variables in the model creation process.

15. The computer-readable medium of claim 11, wherein identifying the plurality of variables includes identifying categorical, Boolean, continuous, and ordinal variables.

16. The computer-readable medium of claim 15, wherein performing the clustering analysis includes using k-means clustering or using support vector machines.

17. A system for performing a method for simplifying a mathematical model, comprising:
a memory;
at least one input device; and
at least one central processing unit in communication with the memory and the at least one input device, wherein the central processing unit is configured to:
obtain a data set and identify a plurality of variables within the data set;
perform a clustering analysis by dividing the data set into groups, where each group has a cluster center;
replace the plurality of variables with a plurality of cluster distances; and
use the plurality of cluster distances as a plurality of independent variables in a model creation process.

18. The system of claim 17, wherein performing the clustering analysis includes performing one of k-means clustering, city block method, or support vector machines.

19. The system of claim 17, wherein replacing the plurality of variables with a plurality of cluster distances includes employing a lossless compression method.

20. The system of claim 17, wherein some or all of the data set is obtained from an external database.
